(19) United States
(12) Patent Application Publication
(10) Pub. No.: US 2017/0227999 A1
(43) Pub. Date: Aug. 10, 2017

(54) Computing Device Comprising Interengaging Modular Computing Units

(71) Applicant: Cybula Ltd., Yorkshire (GB)

(72) Inventor: James Austin, Yorkshire (GB)

(21) Appl. No.: 15/502,020

(22) PCT Filed: Aug. 5, 2015
(86) PCT No.: PCT/GB2015/052259

§ 371 Date: Feb. 6, 2017

(30) Foreign Application Priority Data
Aug. 5, 2014 (GB) 1413883.8

(51) Int. Cl. G06F 1/18; G06F 1/20

(52) U.S. Cl. CPC G06F 1/182; G06F 1/206; G06F 2200/1635; G06F 2200/201

(57) ABSTRACT

A modular computing unit 1 of a generally flat configuration has a housing (10) presenting external facets (10a, 10b), on each of which there is a respective set (11) of external electrical power and signal connectors (12) and physical coupling elements (13). The housing (10) is of generally hexagonal shape, the facets (10a, 10b) being arranged around the circumference of the hexagon. Facets (10a) are inclined upwardly at an angle and alternate with facets (10b) that are inclined downwardly at the same angle. The connector sets (11) are disposed on the facets (10a, 10b) in consistent positions and in a regular array around the housing (10). The physical coupling elements (13) are disposed within or alongside the connector sets (11). Any number of modular computing elements (1) may readily be connected to one another in various different 2D and 3D configurations, with power and signal connections via the connector sets (11).

The present invention relates to computing devices and is concerned particularly with computing devices that comprise a plurality of computing units that intercommunicate.

WO 03/023583 and WO 2014/072732 disclose computing devices that comprise a collection of individual computing elements that intercommunicate and receive power by wireless methods, and can be constructed simply and of a size that can be varied quickly.

Preferred embodiments of the present invention aim to provide generally improved computing devices that may readily be built up from a small size to a large size by adding more computing units that readily engage with and communicate with existing computing units, whilst providing efficient cooling in a simple and effective manner.

According to one aspect of the present invention, there is provided a computing device comprising a plurality of interengaging, modular computing units, each of which comprises a housing, a data processor within the housing, a plurality of external electrical power and signal connectors connected to the data processor and a plurality of physical coupling elements, wherein the housing presents a plurality of facets, said external electrical power and signal connectors are arranged in connector sets on different facets of the housing, for the transfer of electrical power and communications signals with adjacent ones of the modular computing units; and said physical coupling elements secure adjacent ones of the modular computing units to one another.

Preferably, said physical coupling elements comprise permanent magnets.

Preferably, said physical coupling elements are disposed within or alongside said connector sets.

Preferably, each of said connector sets comprises both electrical power and signal connectors.

Preferably, said connector sets are arranged in a regular fashion on said housing.

Preferably, the modular computing units engage one another in different relative orientations.

Preferably, each set of electrical power and signal connectors comprises a plurality of rows of connectors that provide consistent electrical power and signal connections between the modular computing units when engaged with one another in different relative orientations.

Preferably, each of the modular computing units is of a generally flat configuration, having two major facets that are parallel to one another and joined by a plurality of minor facets.

Preferably, each of the major facets is hexagonal.

Preferably, the minor facets are inclined to the major facets.

Preferably, successive minor facets are inclined to the major facets in opposite directions.

Preferably, the minor facets are inclined to the major facets at angles of 57.74 and 122.26 degrees.

Preferably, each of the computing units comprises at least one external heat sink for the respective data processor.

Preferably, for each of the computing units, the respective data processor is mounted internally of the housing on a reverse side of one of the facets.

Preferably, each of the computing units comprises at least two data processors.

Preferably, said external electrical power connectors are of platinum or plated with platinum.

Preferably, said signal connectors comprise metal contacts that engage with one another.

Preferably, said signal connectors are of platinum or plated with platinum.

Preferably, said signal connectors comprise optical signal connectors.

Said computing units may be arranged in a 1D array.

Said computing units may be arranged in a 2D array.

Preferably, said computing units are arranged in a 3D array.

Preferably, said 3D array comprises a tetradecahedron.

Preferably, the tetradecahedron comprises eight irregular hexagons and six squares.

Preferably, each of said irregular hexagons is defined by a printed circuit board on which a respective one of the data processors is mounted.

Preferably, each of said six squares is defined by facets of adjacent computing units on which said connector sets are provided.

Preferably, said 3D array comprises a cluster of tetradecahedra.

Preferably, said 3D array defines passages for the flow of coolant.

A computing device as above may further comprise one or more external connector connected to one or more of said connector sets for the supply of external power to the computing device and/or the exchange of communications signals with the computing device.

Preferably, a computing device as above further comprises a tank in which said computing units are arranged and a coolant liquid in the tank.

Preferably, said coolant liquid is pure water.

For a better understanding of the invention, and to show how embodiments of the same may be carried into effect, reference will now be made, by way of example, to the accompanying diagrammatic drawings, in which:

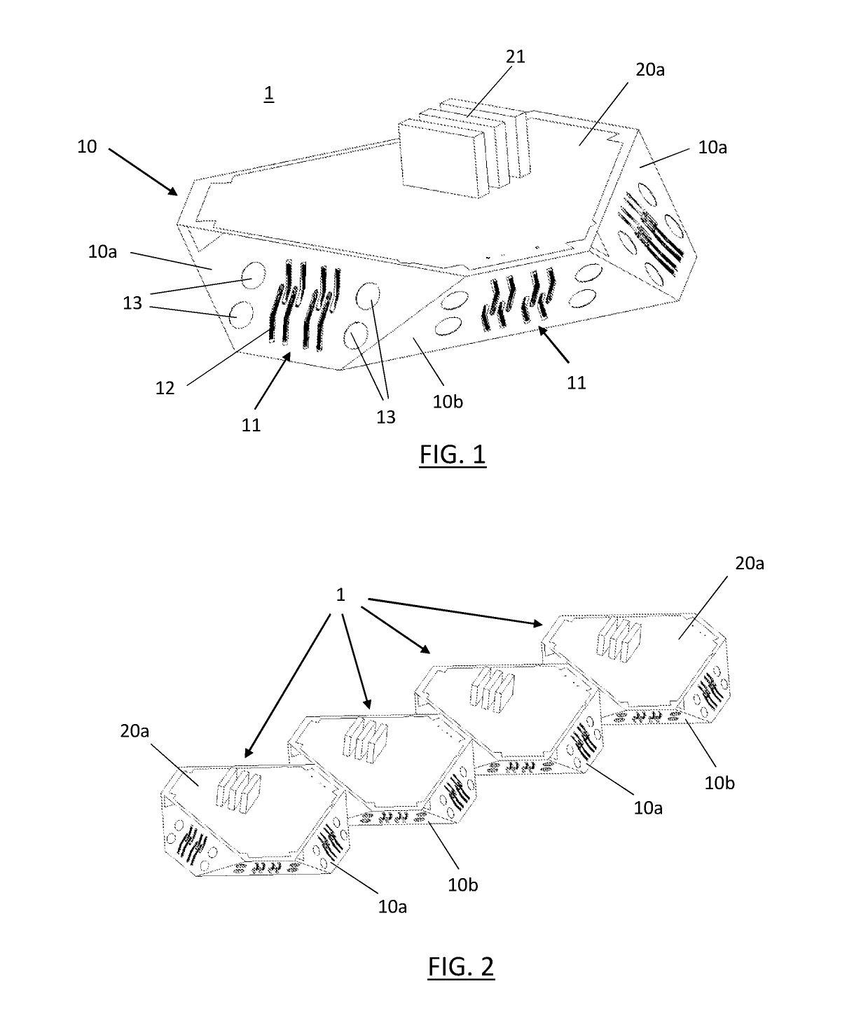

FIG. 1 is a perspective view of a modular computing unit;

FIG. 2 is a perspective view of a plurality of interengaging modular computing units in a 1D array;

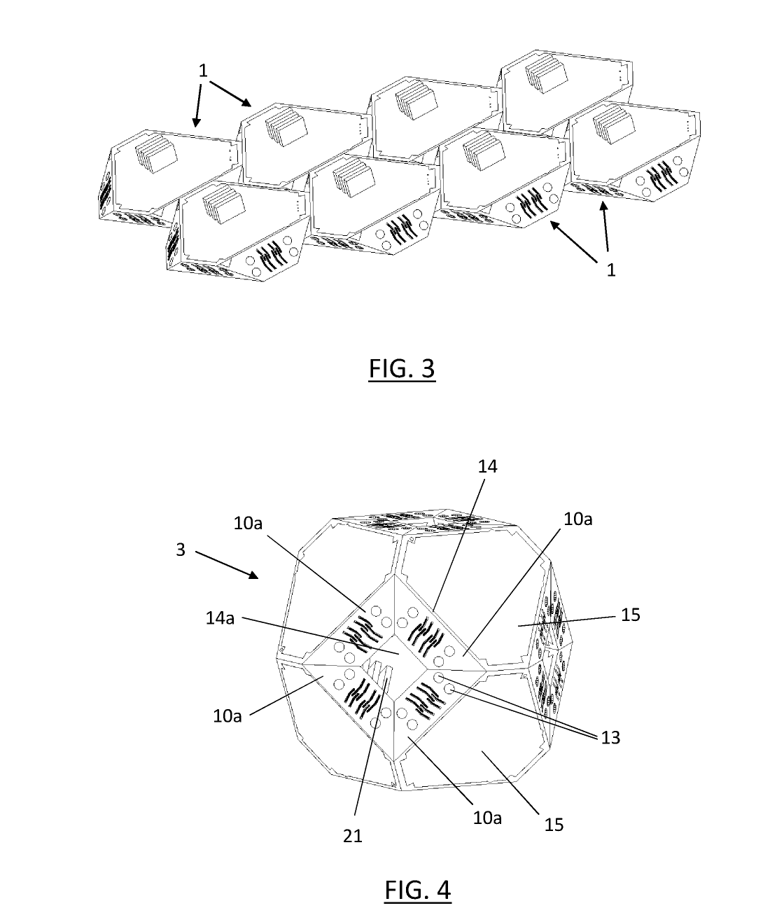

FIG. 3 is a perspective view of a plurality of interengaging modular computing units in a 2D array;

FIG. 4 is a perspective view of interengaging modular computing units arranged in a 3D ‘ball’ configuration;

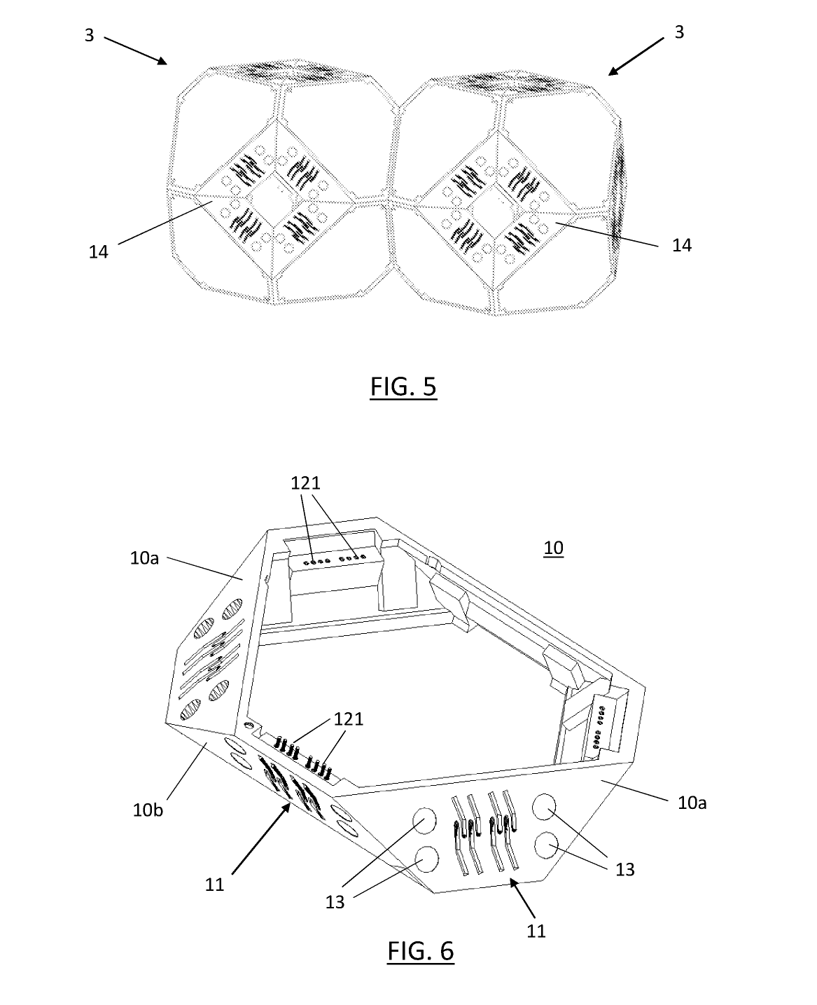

FIG. 5 is a perspective view of two interengaging computing ‘balls’, each of a configuration as shown in FIG. 4;

FIG. 6 is a perspective view of a housing of a modular computing unit;

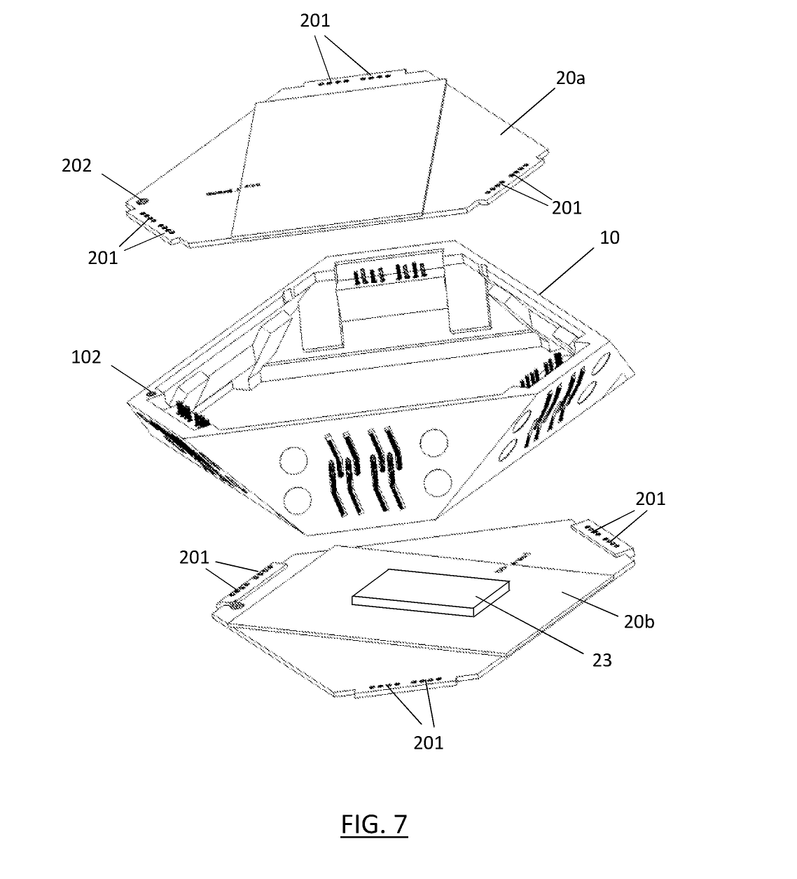

FIG. 7 is an exploded perspective view of a modular computing unit, showing the housing and two pcbs;

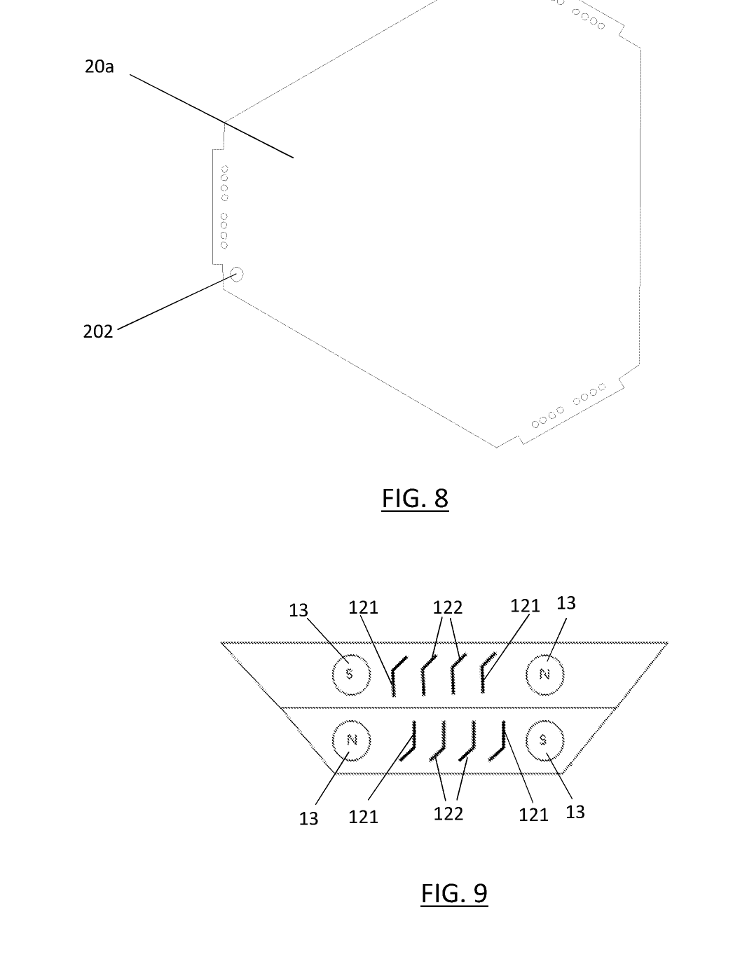

FIG. 8 shows a pcb in plan view;

FIG. 9 shows a connector set on one facet of a modular computing unit;

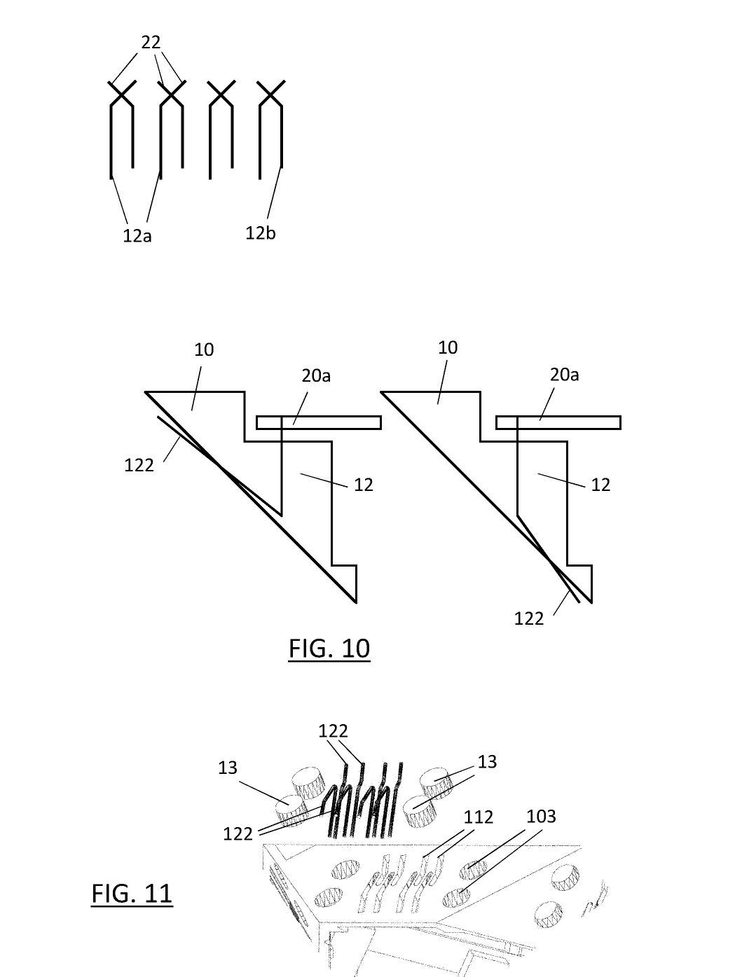

FIG. 10 illustrates electrical power and signal connectors and their connections;

FIG. 11 shows a connector set as an exploded view;

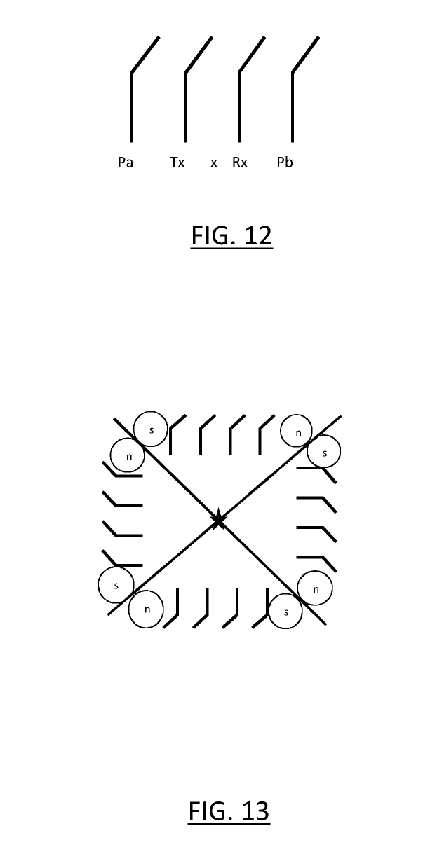

FIG. 12 shows an arrangement of electrical power and signal connectors;

FIG. 13 shows an alternative arrangement of electrical power and signal connectors;

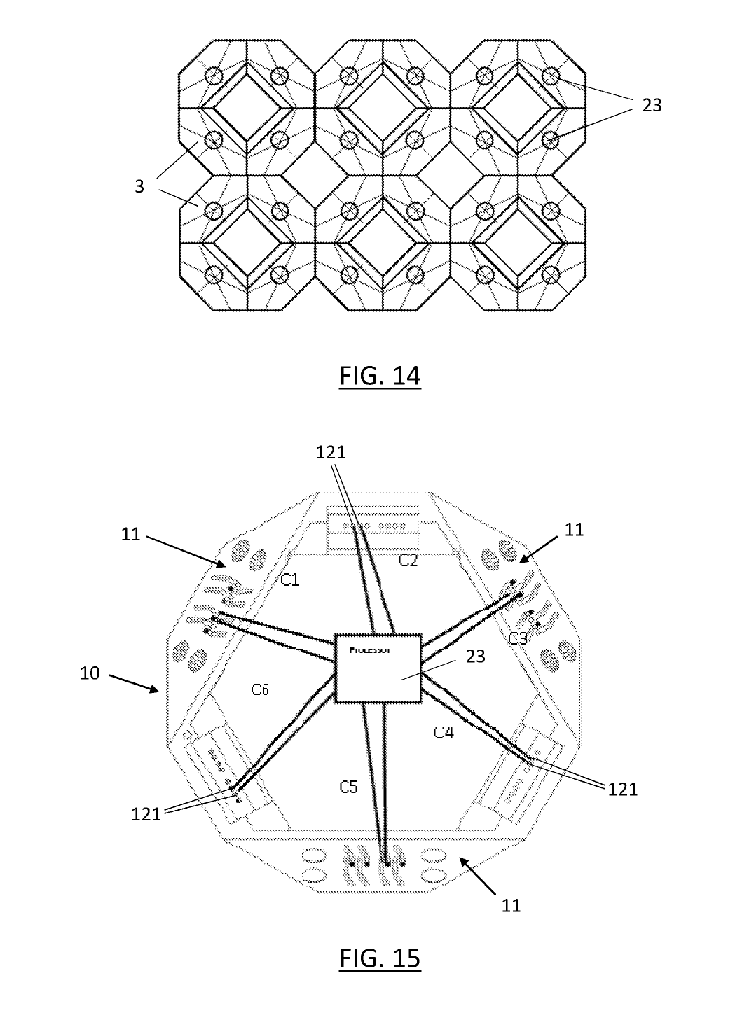

FIG. 14 illustrates connections between processors in 3D assemblies of modular computing units;

FIG. 15 illustrates connections between a processor and connection pins on a housing of a modular computing unit;

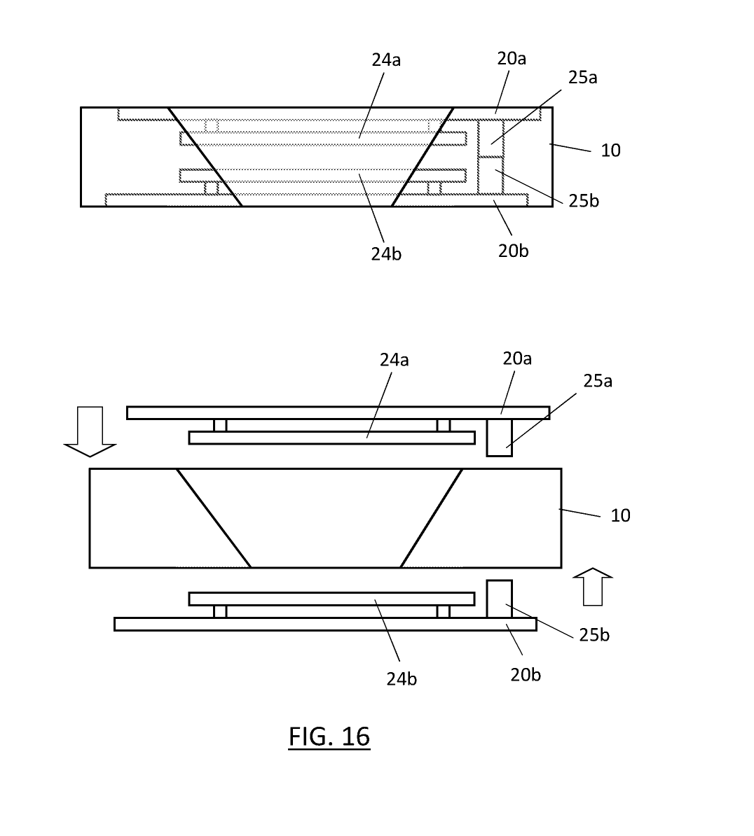

FIG. 16 shows an arrangement of circuit boards in a housing;

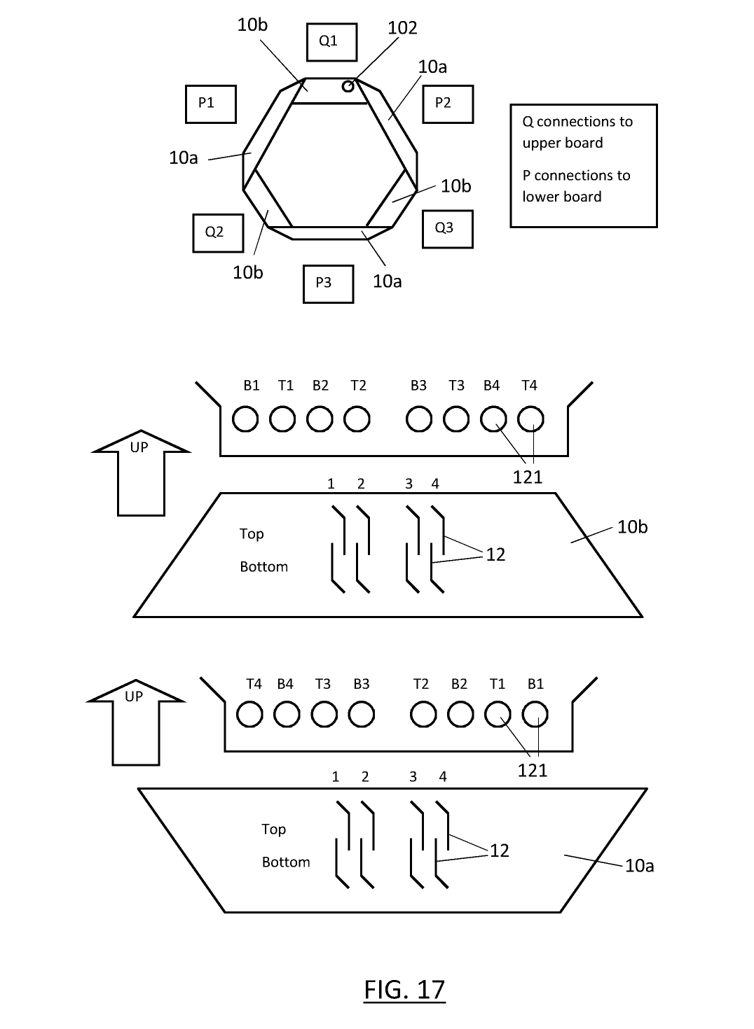

FIG. 17 shows the arrangement of FIG. 16 in an exploded fashion;

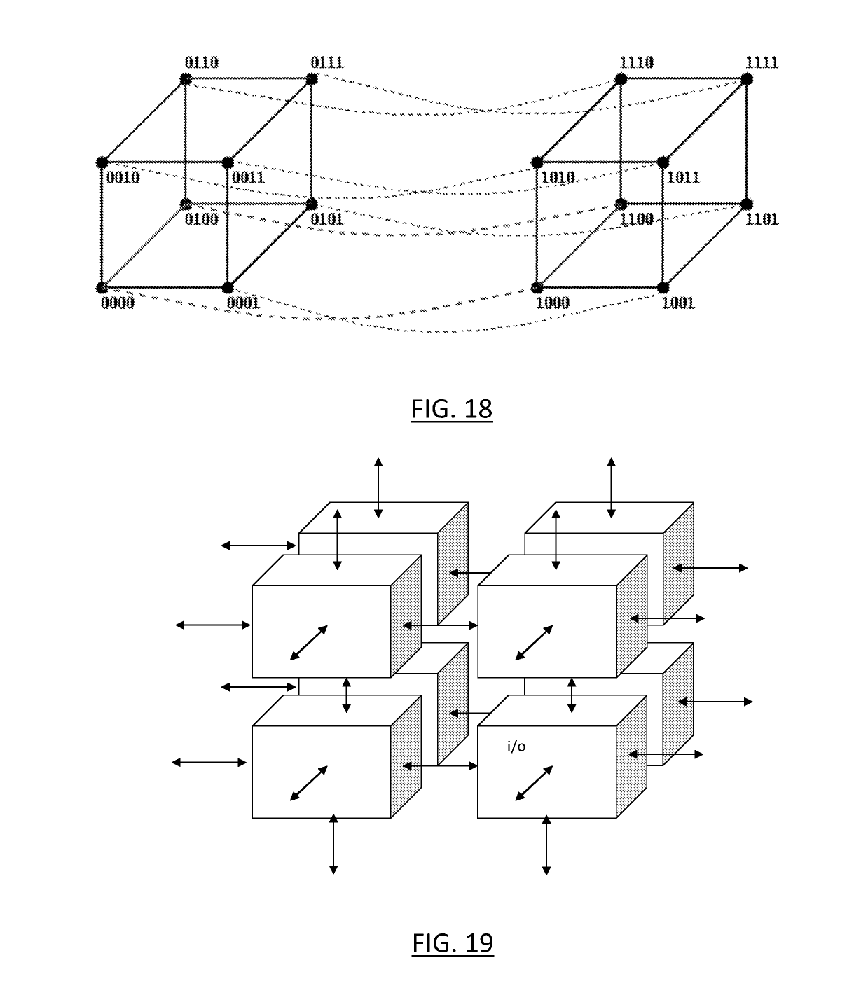

FIG. 18 illustrates the principle of a 4D hypercube;

FIG. 19 illustrates the makeup of a 3D ‘ball’ that comprises 8 computing units and 16 processors;

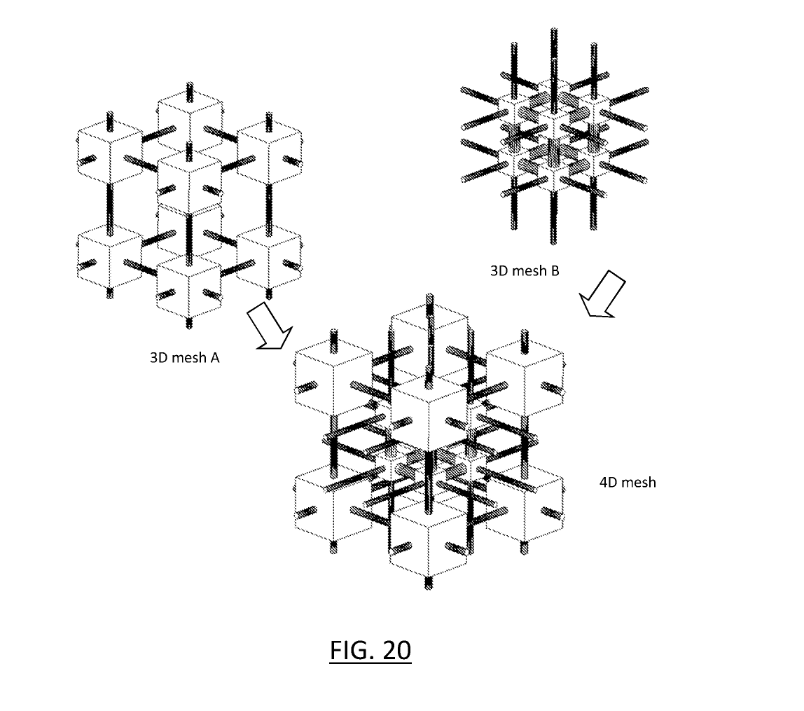

FIG. 20 is another illustration of how a 4D hypercube is formed from two interconnected 3D arrays in a ball configuration;

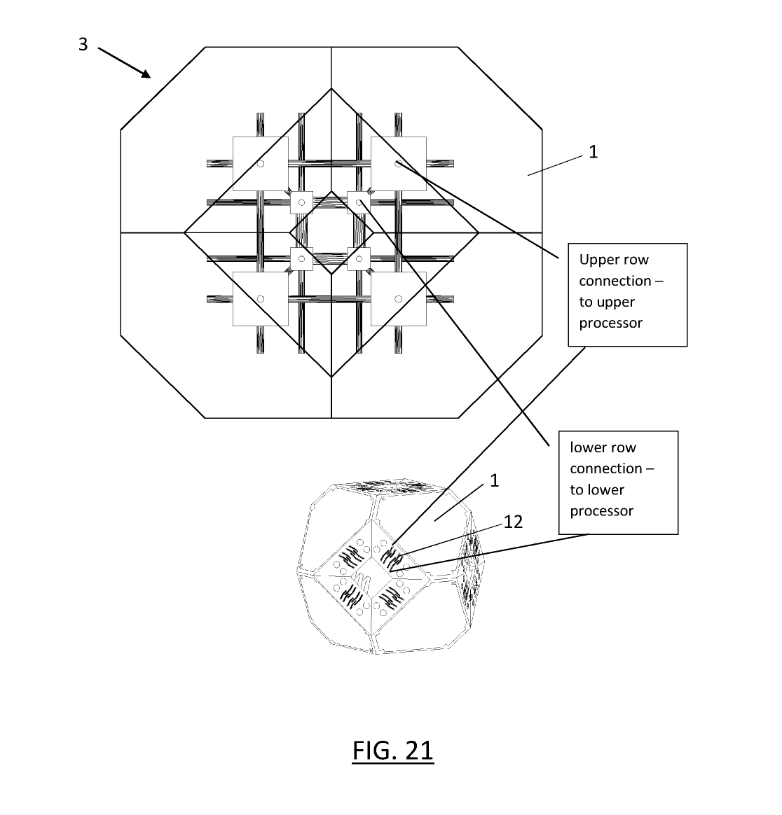

FIG. 21 shows interconnections between two 3D arrays, in relation to connections on the face of a ball comprising modular computing units;

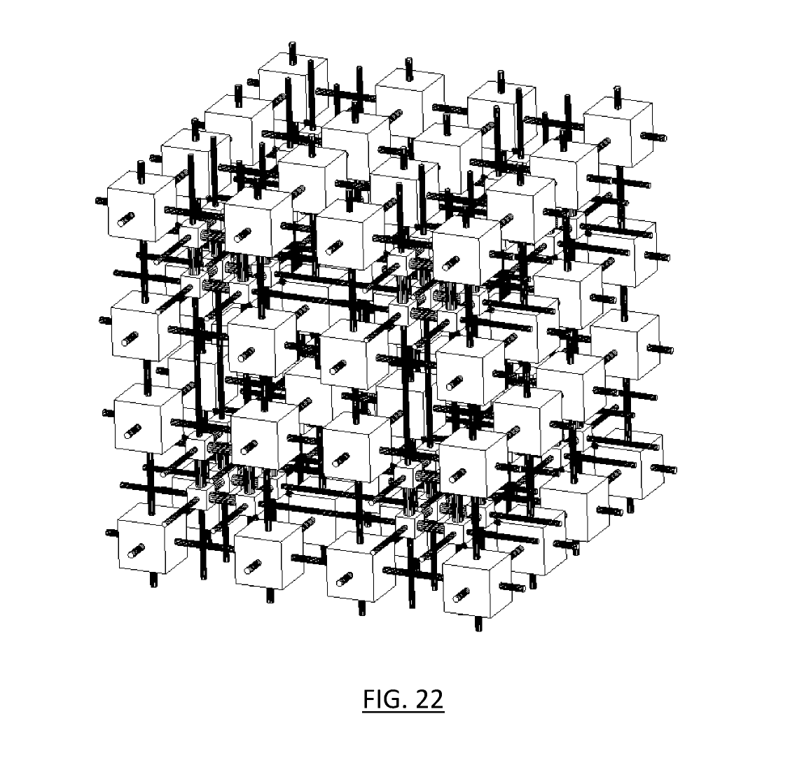

FIG. 22 illustrates a larger computing device comprising eight ‘balls’ that are made up of 4×4×4×2 processors, each with two cores;

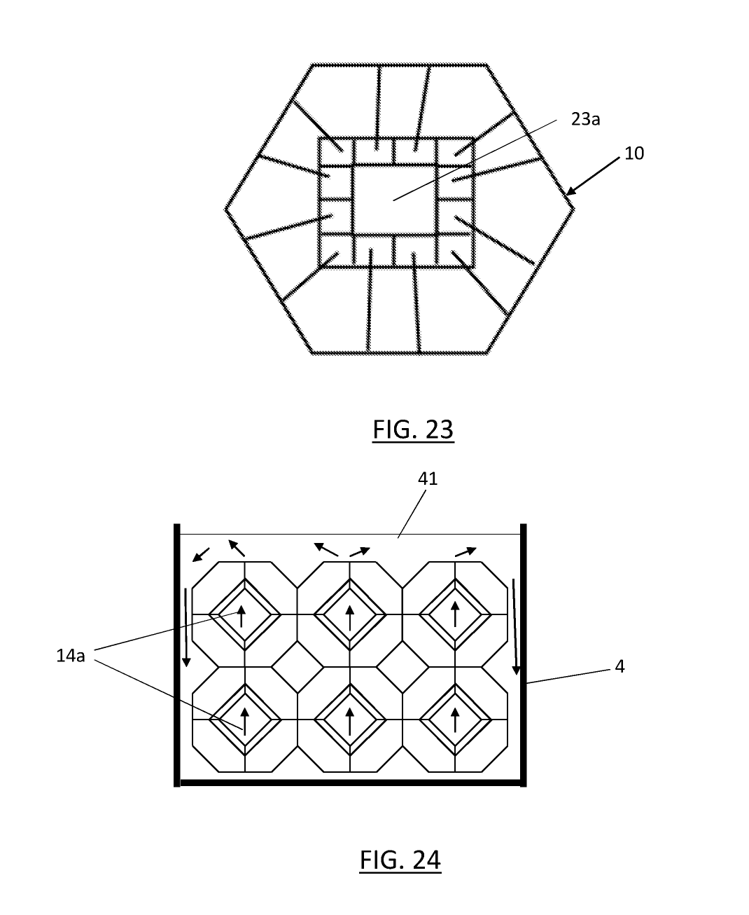

FIG. 23 shows direct connections between a chip and edge connectors in a computing unit; and

FIG. 24 illustrates cooling water flow in a computing device made up of 3D balls.

In the figures, like references denote like or corresponding parts.

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

For convenience, terms of absolute orientation are used in the following to denote the orientation of items as shown in the accompanying drawings. However, such items could be disposed in other orientations, and in the context of this specification, terms of absolute orientation and position, such as “top”, “bottom”, “left”, “right”, “vertical” or “horizontal”, etc. are to be construed accordingly, to include such alternative orientations.

Computing devices are described in the following, assembled from a plurality of interengaging, modular computing units. Each of the computing units has power and signal connections and is capable of computing functions. In this context, the terms “computing” and “data processing” are to be construed widely to include both calculating and communication (including display) functions.

The ethos behind the illustrated embodiments of the invention is that, although any one computing unit is capable of computing functions in its own right, a more powerful computing device is built up by physically interengaging a plurality of modular computing units, which transfer electrical power and communications signals between one another. The more interengaging computing units there are, the more powerful the overall computing device will be. One can start off with a relatively modest computing device and, by adding further computing units, end up with a very powerful computing device. All of the computing units may provide similar computing functions. Alternatively, different computing units may provide different computing functions, provided that they have compatible connections with the other computing units.

Regular challenges, particularly with large computing devices, include supporting the weight of a large number of components and ensuring the cooling of processors. Typically, substantial resources are devoted to addressing such problems. Preferred embodiments of the present invention aim to provide computing devices that can readily be built up from many modular computing units, whilst affording both mechanical support and efficient cooling in a relatively simple manner.

FIG. 1 shows a modular computing unit 1 that comprises a housing 10 presenting a plurality of external facets 10a, 10b, each of which houses a respective set 11 of external electrical power and signal connectors 12 and physical coupling elements 13. The housing 10 is of generally hexagonal shape, the facets 10a, 10b being arranged around the circumference of the hexagon. As may be seen in FIG. 1, facets 10a are inclined upwardly at an angle and alternate with facets 10b that are inclined downwardly at the same angle.

As may be seen in FIG. 1, the connector sets 11 are arranged in a regular fashion on the housing 10. That is, they are disposed on the facets 10a, 10b in consistent positions and in a regular array around the housing 10. The physical coupling elements 13 are disposed within or alongside the connector sets 11.

A first printed circuit board (pcb) 20a is mounted on top of the housing 10. It carries a processor (not visible in FIG. 1) that is thermally connected to a heat sink 21 on the upper face of the pcb 20a. A similar, second pcb 20b (not visible in FIG. 1), is mounted on the lower face of the housing 10.

Thus, the modular computing unit 1 is of a generally flat configuration, having two major facets that are afforded by the pcbs 20a, 20b, parallel to one another and joined by a plurality of minor facets 10a, 10b, successive minor facets 10a, 10b being inclined to the major facets in opposite directions. It is preferred that the angles of inclination of the minor facets 10a, 10b to the major facets afforded by the pcbs 20a, 20b are 57.74 and 122.26 degrees. As the pcbs 20a, 20b are substantially parallel, each of the facets 10a, 10b will make an acute angle of 57.54 degrees with one of the pcbs 20a, 20b and a complementary obtuse angle of 180−57.74=122.26 degrees with the other of the pcbs 20a, 20b.

The modular computing unit 1 will be described in further detail below. First, some examples of its advantageous geometrical properties will be given.

FIG. 2 shows a 1D array (i.e. a line) of modular computing units 1. For each adjacent pair of computing units 1, the downwardly facing facet 1b of one of the units 1 engages an opposing upwardly facing facet 1a of the adjacent unit 1, the opposing facets 1a, 1b being substantially parallel to one another. In this example, the physical coupling elements 13 comprise permanent magnets, the polarities of which ensure that the opposing facets 10a, 10b of adjacent computing units 1 are magnetically attracted to one another to hold the adjacent computing units 1 firmly together, whilst allowing the units 1 to be rotated relative to one another. As will be described further below, the external electrical power and signal connectors 12 of opposing facets 10a, 10b provide electrical power and signal connections between the units 1.

FIG. 3 shows a 2D array of modular computing units 1, which interengage in a manner similar to that of FIG. 2, but in two dimensions.

FIG. 4 shows a particularly advantageous arrangement in which eight modular computing units 1 interengage to form a 3-D structure that we refer to as a “ball” 3. Here, each set of four adjacent facets 10a forms a square face 14 having a central square aperture 14a that leads to the interior of the ball 3. Pairs of opposing facets 10b (not visible in FIG. 4) secure adjacent units 1 together by means of attraction of the permanent magnets 13. Pcbs 20a afford irregular hexagon faces 15 of the ball 3. The ball 3 has eight irregular hexagonal faces 15 and six square faces 14, constituting a tetradecahedron. Although possessing axes of symmetry, the hexagons are regarded as irregular because all sides are not of the same length. Due to the inclination of the facets 10a, 10b, each hexagonal face 15 has three sides of one, shorter length and three sides of another, longer length.

FIG. 5 shows two balls 3 that interengage via their respective square faces 14, secured again by attraction of the permanent magnets 13, the connector sets 11 providing electrical power and signal connections between the balls 3. Any number of balls 3 can be added to the pair shown in FIG. 5, by bringing respective pairs of square faces 14 into engagement. The holes 14a afford passages for the flow of coolant fluid through the computing device built up from the balls 3. The coolant fluid may be either gas or liquid—typically, air or water.

In the interests of clarity, external heat sinks 21 as shown in FIGS. 1 to 3 are not shown in FIGS. 4 and 5. One internal set of heat sinks 21 can be seen through the aperture 14a in FIG. 4. It will be appreciated that the inclination of the hexagonal faces 15 affords space between the balls 3 of FIG. 5 for external heat sinks 21 as previously illustrated. However, it is to be appreciated that, depending upon processor power requirements and cooling configuration, it may not always be essential to provide projecting heat sinks such as the heat sinks 21, either externally or internally of the ball 3.

A modular computing unit 1 will now be described in further detail.

FIG. 6 shows the housing 10 of a computing unit 1, with inclined facets 10a, 10b and connector sets 11, which include permanent magnets 13 of opposing polarities (discussed further below) and external electrical power and signal connectors 12 that terminate in pins 121 arranged in sets within the housing 10, for contact with upper and lower pcbs 20a and 20b, as shown in FIG. 7. Thus, each of the pcbs 20a, 20b has 3 sets of contacts 201, arranged to receive the respective sets of pins 121 and make electrical contact with them on the pcb. Each of the pcbs 20a, 20b carries a respective processor 23 internally of the housing 10, the connection pins of each processor 23 being connected to respective ones of the contacts 201.

The pcbs 20a, 20b are assembled with the housing 10 to afford a fluid-tight assembly. For example, once all of the components are in place, the internal volume of the housing 10 may be filled with an electrically insulating but heat conducting potting compound, which extends over the surfaces of the pcbs 20a, 20b, so that the whole computing unit 1 may subsequently be immersed in pure water or other fluid or liquid. The external electrical power and signal connectors 12 are of platinum or platinum-plated (e.g. platinum-plated titanium), which is resistant to electrolysis.

In practice, 100% pure water may be difficult to realise and/or maintain. Therefore, in the context of this specification, pure water means water having an electrical conductivity of 5×10⁻³ S/m or less. It may be provided in the form of deionised or distilled water, or produced in any other way. It may have an electrical conductivity in a range having an upper limit of 5×10⁻³, 1×10⁻³, 500×10⁻⁶ or 5×10⁻⁶ S/m and a lower limit of zero, 5×10⁻⁶, 500×10⁻⁶ or 5×10⁻³ S/m.

As the water is of low electrical conductivity, it has very few ions. As the electrical power and signal connectors 12 are of platinum or platinum-plated, they are resistant to electrolysis. Thus, there is no significant tendency for the water to become ionised and conduct electrical current. This makes it possible to place the electrical power and signal connectors 12 in water, with negligible risk of short circuits. Placing metallic electrical connectors in water is highly counter-intuitive but, surprisingly, has been found to be effective if the water has low electrical conductivity as specified and the connectors are resistant to electrolysis as specified.

Although the pure water provides negligible electrical conduction, it remains effective at conducting heat and can therefore continue to function as a highly effective but relatively cheap coolant.

Deionising or other purifying devices may be provided to maintain the desired purity and therefore low electrical conductivity of the water.

FIG. 8 shows one of the pcbs 20a, 20b in plan view. To position the pcbs correctly, a small dot 202 on the upper pcb 20a registers with a corresponding dot 102 on the housing 10, as seen in FIG. 7.

FIG. 9 shows one of the connector sets 11 on a respective facet 10a. The connector set 11 comprises an upper row of electrical power and signal connectors 12, with an S pole of a permanent magnet 13 at their left hand side and an N pole of a permanent magnet 13 at their right hand side. Each of the electrical power and signal connectors 12 in that row has an upright portion 121 and, above it, an angled portion 122, at an angle of 45°.

The connector set 11 comprises a lower row of electrical power and signal connectors 12 below the upper row, with an N pole of a permanent magnet 13 at their left hand side and an S pole of a permanent magnet 13 at their right hand side. Each of the electrical power and signal connectors 12 in that row has an upright portion 121 and, below it, an angled portion 122, at an angle of 45° in the opposite direction to the angled portions 122 of the upper row.

This configuration of the connector set 11 ensures that, whatever way up two adjacent computing units 1 may be, each S magnetic pole on one of the units is opposite an N magnetic pole on the other of the units, to ensure good magnetic attraction between the units 1. It also ensures that the angled portions 122 of the electrical power and signal connectors 12 cross over one another at a right angle, to ensure good electrical contact. However, angles other than 45° may be adopted for the angled portions 122.

FIGS. 10 to 13 show the electrical power and signal connectors 12 and magnets 13 in further detail.

In the upper part of FIG. 10, electrical power and signal connectors 12a are from one computing unit 1, and electrical power and signal connectors 12b are from an adjacent computing unit 1. As may be seen, the angled portions 122 of the electrical power and signal connectors 12a, 12b cross over one another at a right angle, to ensure good electrical contact.

In the lower part of FIG. 10, which shows cross-sections through the housing 10, electrical power and signal connectors 12 connect with a pcb 20a at their upper ends and pass through the housing 10, their angled portions 122 projecting externally of the housing 10. An upper set of electrical power and signal connectors 12 (bottom left of FIG. 10) has their angled portions 122 projecting upwardly. A lower upper set of electrical power and signal connectors 12 (bottom right of FIG. 10) has their angled portions 122 projecting downwardly.

Whilst FIG. 10 is a diagrammatic representation, FIG. 11 illustrates a connector set 11 in one example of a physical realisation, in an exploded view.

The housing 10 is provided with recesses 103 to receive the permanent magnets 13 and slots 112 to receive the electrical power and signal connectors 12, which are arranged in two rows, with their angled portions 122 extending upwardly and downwardly respectively.

FIG. 12 shows one row of electrical power and signal connectors 12. The connectors Pa, Pb at the ends of the row carry power. The connectors Tx and Rx are for transmitting and receiving electrical communications signals, to and from adjacent computing units 1. The electrical power and signal connectors 12 are arranged on the housing 10 so that the centre of rotation×lies at the centre of the row of connectors 12. Here, the centre of rotation is the point about which the computing unit 1 is rotated to invert it.

When two computing units 1 are interengaged, a first row of electrical power and signal connectors 12 on one of the units 1, as shown in FIG. 12, engages a second, corresponding row of connectors 12 on the other of the units, the second row being a mirror image of the first, when they engage. This corresponds to the engaging rows of pins 12a, 12b as shown at the top of FIG. 10. Thus, the Tx connector of each computing unit 1 touches the Rx connector of the other computing unit 1. The power connectors Pa, Pb do likewise. Each computing unit 1 includes rectifier circuitry to handle correct polarities of the power connectors Pa, Pb.

Communication between computing units 1 via the Tx and Rx connectors is preferably by serial or parallel protocol. External input and output is via connector sets 11 that are on an outer face of the computing device. Communications methods can be selected to suit applications, but low voltage differential signalling is a preferred method, due to its robustness in noisy conditions.

As discussed above, and as shown for example in FIG. 9, the connector sets 11 are arranged so that adjacent computing units 1 can be interengaged either way up. Thus, if one of the units 1 is inverted, the electrical power and signal connectors 12a, 12b still interengage as shown at the top of FIG. 10. The arrangement of the rows of connectors in the connector sets therefore provide consistent electrical power and signal connections between the modular computing units 1 when engaged with one another in different relative orientations.

FIG. 13 shows a development of FIG. 12, in which four rows of magnets and electrical power and signal connectors are arranged with fourfold symmetry around a central star, allowing mating connectors to be fitted in any of four positions. Such an arrangement can be seen in the square faces 14 of balls 3 in FIGS. 4 and 5, indicating that the balls 3 can be interengaged in any of four rotations.

FIG. 14 shows how processors 23 are mapped onto a 3D structure, and connections to each processor 23, in a computing device comprising a plurality of balls 3 composed of computing units 1. Each processor 23 is represented by a dot and provides six communications channels (Tx and Rx) to connector sets 11 at the edges of its respective computing unit 1. This is shown in FIG. 15, where a processor 23 provides six communication channels C1 to C6 to contact pins 121 of respective connector sets 11.

FIG. 16 further illustrates connections within a computing unit 1. The upper part of FIG. 16 shows components in an assembled state. The lower part of FIG. 16 shows components in an exploded view.

As mentioned above, there are two pcbs 20a, 20b on each computing unit 1, respectively at the top and bottom of the housing 10, each carrying a respective processor 23 on a card 24a, 24b. Each processor 23 connects to the contact pins 121 on all six facets of the housing 10. In addition, each of the two processor cards 24a, 24b carries a respective connector 25a, 25b that interconnect to provide electrical power and signal connections between the two processor cards 24a, 24b.

Further connections details are shown in FIG. 17. The housing 10 is shown diagrammatically in the upper part of FIG. 17. As previously described, each facet of the housing 10 carries a respective connector set 11. The connector sets 11 on the upwardly facing facets 10a are connected to the upper processor card 24a, indicated by three sets Q1 to Q3, whilst the connector sets 11 on the downwardly facing facets 10b are connected to the lower processor card 24b, indicated by three sets P1 to P3. Dot 102 on the housing 10 indicates what is conveniently regarded as the ‘top’ of the housing 10—although, in use, the housing 10 may actually be in any orientation.

The middle part of FIG. 17 shows a plan view onto contact pins 121 of a facet 10b and, below that, a side elevation of the facet 10b, with the electrical power and signal connectors 12 of the respective connector set 11. As previously described, the connectors 12 are arranged in two rows of four, labelled Top and Bottom and 1 2 3 4 in FIG. 17. Reading the contact pins 121 from left to right in the figure, they are arranged as Bottom Row Contact 1 (B1), Top Row Contact 1 (T1), Bottom Row Contact 2 (B2), Top Row Contact 2 (T2), and so on.

The lower part of FIG. 17 is similar to the middle part, but shows a plan view onto contact pins 121 of a facet 10a and, below that, a side elevation of the facet 10a, in the same orientation as facet 10b above, with the electrical power and signal connectors 12 of the respective connector set 11. In this case, reading the contact pins 121 from left to right in the figure, they are arranged as Top Row Contact 4 (T4), Bottom Row Contact 4 (B4), Top Row Contact 3 (T3), Bottom Row Contact 3 (B3), and so on.

In FIG. 17, all of the top row contact pins T1-T4 go to the upper processor card 24a and all of the bottom row contact pins B1-B4 go to the lower processor card 24b. This means that some communications signals need to be routed via the inter-board connectors 25a, 25b in the computing unit 1.

Various processor connections are shown in Table 1 below. Table 2 shows the legends for Table 1.

TABLE 1
Connections to processors

| | Pin | | | | | | | |
|---|---|---|---|---|---|---|---|---|
| Plug group | B1 | T1 | B2 | T2 | B3 | T3 | B4 | T4 |
| Q1 | +/− | −/+ | rxl1 | rxu1 | txl1 | txu1 | −/+ | +/− |
| Q2 | +/− | −/+ | rxl2 | rxu2 | txl2 | txu2 | −/+ | +/− |
| Q3 | +/− | −/+ | rxl3 | rxu3 | txl3 | txu3 | −/+ | +/− |
| P1 | +/− | −/+ | rxl4 | rxu4 | txl4 | txu4 | −/+ | +/− |
| P2 | +/− | −/+ | rxl5 | rxu5 | txl5 | txu5 | −/+ | +/− |
| P3 | +/− | −/+ | rxl6 | rxu6 | txl6 | txu6 | −/+ | +/− |

TABLE 2
Legend for Table 1

| Label | Meaning |
|---|---|
| tx | Transmit |
| rx | Receive |
| uN | Upper processor |
| lN | Lower processor |
| +/− | power |
| −/+ | power |

As indicated above, there is a transmit and a receive line for each communication channel and a pair of power connections in each row. The power lines can be either polarity—thus rectification is needed within the computing unit 1 to ensure the processors receive the correct polarity.

In each computing unit 1, the upper −/+ power connectors are interconnected and the +/− power connectors are interconnected, likewise for the lower power connectors. Each set of power connectors (upper and lower) has its own rectifier.

The computer architecture of a computing device built up from computing units 1 may be based on a 4D hypercube, although the attractiveness of the system of computing units 1 is that they can be also used to implement 1D, 2D and 3D connection structures, as indicated above. We believe 4D to be particularly effective, due to its good communications performance.

A representation of a 4D hypercube connection structure is shown in FIG. 18. This is formed from two 3D computer networks as shown on the left and right of the figure. A 3D connection structure forms a cube in 3D space, with a processor at each corner of the cube. The solid lines are communications lines between the processors. To form a 4D connection structure, the two cubes are interconnected by linking corresponding positions of processors in each 3D system (broken lines in FIG. 18). This is called a hypercube as it has the mathematical properties of a cube but cannot be drawn as a 3D image.

In FIG. 18, the square connection of processors 0110, 0111, 0101, 0100 constitutes a row of the meshed 3D cubes. The two interconnected lines 0000, 0100 and 1000, 1100 constitute a column of the meshed 3D cubes.

A 4D system has very good communications efficiency, but other topologies are possible.

This example shows a 4D hypercube with only 2 processors per dimension. In practice this is likely to be much larger. Ball structures 3 as shown in FIGS. 4 and 5 may form a 2×2×2×2 4D hypercube with 16 processors. This is illustrated in FIG. 19, where each block contains typically 2 processors.

FIG. 20 shows the makeup of a ball 3. Each computing unit 1 contains a pair of two-core processors. These are the upper (A) and lower (B) processors. In a ball there are 8 computing units 1, 16 processors and 32 cores. In FIG. 22, each cube is a processor with two cores. The upper processors form one 3D mesh A, the lower processors form a second 3D mesh B—due to the interconnections between the upper and lower processor cards 24a, 24b and the interconnections between the computing units 1 themselves. The two 3D meshes are interconnected to form a 4D system.

FIG. 21 shows connections relating to a ball 3 comprising eight computing units 1. The image shows a group of connections for the top right computing unit 1 of the ball 3. The upper processor is connected to the upper row of electrical power and signal connectors 12 and the lower process is connected to the lower row of electrical power and signal connectors 12, as previously described.

More computing units 1 may be added to form more balls and a larger processor, as shown in FIG. 22, which illustrates an 8 ball system made up of 4×4×4×2 processors—each with two cores.

In the above description, processors 23 are mounted on cards 24a, 24b, which in turn are connected to connector sets 11. An alternative is to make direct connections between pins of a processor chip 23a and connector sets on the sides of a housing 10, as illustrated diagrammatically in FIG. 23.

One of the key requirements of a computing device is the effective cooling of high performance processors. This is particularly important in 3D compact systems such as those illustrated, due to the small space for coolant. Computer devices as illustrated may be designed to be immersed in water and still function normally, or they can be used dry with air cooling—both forced or convection. To achieve this, the computing units 1 are made watertight, by which we mean that all components are protected sufficiently to allow the modular computing element 1 to function when immersed in water.

To ensure that the connections between the computing units 1 can work in water with no degradation of performance, the connectors 12 are plated in (or made of) platinum, known to be resistant to electrolysis, which could otherwise etch away the connectors. To minimise current flowing in the water, de-ionised water is used. This combination allows the computing units 1 to be immersed with no, or little current flowing through the water between the electrical power and signal connectors. No metal is used for the housing 10 that might introduce ions into the water and allow a current to flow. The housing 10 is preferably made of a suitable plastics material. The magnets 13 are coated in sealer to prevent any contamination of the water. As the platinum connectors 12 are very stable they do not contribute ions into the water.

Thus the system can be immersed in water. Typically, other methods require either piping of water to a heat sink or liquid that is non-conductive—these are both more costly and/or more complex to implement.

FIG. 24 shows a computing device built of balls 3 in a water tank 4, using convection cooling by pure water 41. The shape of the balls 3 is such that there are square holes 14a in the faces of the balls to allow water or air to pass through the system. To power the system, computing units 1 with power wires attached may be used. For example, an input power connector may engage with one of the connector sets 11 and be provided with power cables for connection to an external power supply. In practice, many external power connectors may engage with many connector sets 11 on the periphery of a computing device, and likewise for signal connectors, allowing for significant power and communications transmission, as typically needed for high performance systems.

In use, a computing device built of computing units 1 may be run selectively on air or water as coolant, giving flexibility of choice. Conventional systems are generally designed to be cooled by either air or water specifically, without flexibility of choice.

When a computing device built of computing units 1 is small, cooling by air is possible due to relatively low heat output from the device. As computing units 1 are added, the computing device may get to a point where water is needed as coolant, due to the amount of heat produced. Water generally has a much larger ability to remove heat than air.

As illustrated in FIG. 24, the computing device contains no racking as used in conventional systems. The balls 3 are self-supporting. This reduces cost and improves expandability. In conventional systems, a rack is typically used that has a given capacity for processors. The upfront cost of the rack can be high. With embodiments of the present invention, this may not be needed, and thus start-up costs may be low.

One issue with known rack designs is that, although they may allow reasonable connectivity within the rack, connectivity and communications performance between racks can suffer, due to the wiring needed to cross-link rack cabinets. With embodiments of the present invention with no racks, a system can be built as a single unit, maintaining communication between all the processors.

It is to be noted that, in FIG. 24, the water 41 acts to support the structure. By designing the computing units 1 to be of neutral buoyancy (they don't float or sink), the overall pressure on computing units 1 at the base of the tank 4 from computing units 1 above is zero. Without this, large structures would collapse under their own weight.

Air and water are mentioned above as coolants, by way of example. As explained, pure water is particularly preferred. However, in general, any fluid may be used as a coolant.

In all cases, forced coolant flow may be provided, as may heat-exchanging devices to cool the coolant fluid.

There are a number of processors that could be used in a computing device built of computing units 1. Choice of processor is typically up to the designer of the device. Examples of current processors that may be used include XYLINX ZYNC (Board Zedboard/microzed), and STM32F4 (Board ST discovery).

It is to be noted that computing units 1 may be removed from and added to a computing device whilst it is running, allowing mission critical systems to be altered without stopping the system. An important feature of the physical interconnection of the computing units 1 is that the configuration of the electrical and signal connections and the magnetic fixings allows the computing units 1 to slide over each other to make and break electrical power and signal connections. This facilitates the introduction of computing units 1 and also removal of computing units 1 individually from a computing device, without having to unpack many other computing units 1.

Preferred embodiments of the invention may provide the following advantages:
Compact 3D design.
Quick and easy to build.
Scalable from 1 to millions of processors.
Very low cost.
Can be cooled by liquid or air.
Low power.
Flexible architecture.
No specialist knowledge needed to build one.
Very low start-up costs.
Open design.

The shape of the illustrated balls 3 is that of a tetradecahedron with six square faces and eight irregular hexagonal faces presented by the pcbs 20a,b. Whilst the balls 3 are conveniently built up from the modular computing units 1, they could be constructed in an alternative manner, whilst retaining their overall physical shape and configuration and their operational features—for example, if it were not considered necessary to provide the option of 1D and 3D arrays, as afforded by the modular computing units 1.

Whilst permanent magnets 13 are preferred to couple computing units 1 together, some or all of them may be replaced with electromagnets, to facilitate coupling and de-coupling of the units 1.

Physical coupling elements other than magnetic couplings may be used.

Whilst the illustrated computing units 1 are preferably connected directly together by the magnets 13, they could alternatively be connected indirectly, by intermediate coupling elements.

Whilst the illustrated computing units 1 have metallic connectors 12 that make physical contact for the transfer of both electrical power and communications signals between the units, alternative signal connectors could be optical connectors, which do not require physical contact, although physical contact is possible.

Whilst it is convenient and efficient for each connector set 11 to include both electrical power and signal connectors 12, adjacent to the magnetic coupling elements 13, it is possible for different connector sets to be for electrical power only or for signals only. Also, not every facet 10a, 10b of the units 1 need be provided with a connector set and/or magnets 13.

It is convenient for the housings 10 to be generally flat with substantially parallel major faces (the pcbs 20a, 20b), but not essential.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivates) indicates one feature or more that is preferred but not essential.

The reader's attention is directed to all and any priority documents identified in connection with this application and to all and any papers and documents which are filed concurrently with or previous to this specification in connection with this application and which are open to public inspection with this specification, and the contents of all such papers and documents are incorporated herein by reference.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computing device comprising a plurality of interengaging, modular computing units, each of which comprises a housing, a data processor within the housing, a plurality of external electrical power and signal connectors connected to the data processor and a plurality of physical coupling elements, wherein the housing presents a plurality of facets, said external electrical power and signal connectors are arranged in connector sets on different facets of the housing, for the transfer of electrical power and communications signals with adjacent ones of the modular computing units; and said physical coupling elements secure adjacent ones of the modular computing units to one another.

2. A computing device according to claim 1, wherein said physical coupling elements comprise permanent magnets.

3. A computing device according to claim 1, wherein said physical coupling elements are disposed within or alongside said connector sets.

4. A computing device according to claim 1, wherein each of said connector sets comprises both electrical power and signal connectors.

5. (canceled)

6. A computing device according to claim 1, wherein the modular computing units engage one another in different relative orientations.

7. A computing device according to claim 6, wherein each set of electrical power and signal connectors comprises a plurality of rows of connectors that provide consistent electrical power and signal connections between the modular computing units when engaged with one another in different relative orientations.

8. A computing device according to claim 1, wherein each of the modular computing units is of a generally flat configuration, having two major facets that are parallel to one another and joined by a plurality of minor facets.

9. A computing device according to claim 8, wherein each of the major facets is hexagonal.

10. A computing device according to claim 8, wherein the minor facets are inclined to the major facets and successive minor facets are inclined to the major facets in opposite directions.

11. (canceled)

12. A computing device according to claim 10, wherein the minor facets are inclined to the major facets at angles of 57.74 and 122.26 degrees.

13. (canceled)

14. (canceled)

15. (canceled)

16. A computing device according to claim 1, wherein said external electrical power connectors are of platinum or plated with platinum.

17. A computing device according to claim 1, wherein said signal connectors comprise metal contacts that engage with one another and are of platinum or plated with platinum.

18. (canceled)

19. A computing device according to claim 1, wherein said signal connectors comprise optical signal connectors.

20. A computing device according to claim 1, wherein said computing units are arranged in a 1D, 2D or 3D array.

21. (canceled)

22. (canceled)

23. A computing device according to claim 20, wherein said 3D array comprises a tetradecahedron or a cluster of tetradecahedra.

24. A computing device according to claim 23, wherein the tetradecahedron comprises eight irregular hexagons and six squares.

25. (canceled)

26. (canceled)

27. (canceled)

28. A computing device according to claim 20, wherein said 3D array defines passages for the flow of coolant.

29. A computing device according to claim 1, further comprising one or more external connector connected to one or more of said connector sets for the supply of external power to the computing device and/or the exchange of communications signals with the computing device.

30. A computing device according to claim 1, further comprising a tank in which said computing units are arranged and a coolant liquid in the tank.

31. A computing device according to claim 30, wherein said coolant liquid is pure water.

32. (canceled)
